(19) United States
(12) Patent Application Publication
(10) Pub. No.: US 2024/0100884 A1
(43) Pub. Date: Mar. 28, 2024

(54) Optimized Architecture of a Civil Engineering Tire

(71) Applicant: COMPAGNIE GENERALE DES ETABLISSEMENTS MICHELIN, Clermont-Ferrand (FR)

(72) Inventors: François BARBARIN, Clermont-Ferrand Cedex 9 (FR); Jean-Luc GUERBERT-JUBERT, Clermont-Ferrand Cedex 9 (FR); Philippe MANSUY, Clermont-Ferrand Cedex 9 (FR); Olivier REIX, Clermont-Ferrand Cedex 9 (FR); Sébastien NOEL, Clermont-Ferrand Cedex 9 (FR); Lucas LAUBY, Clermont-Ferrand Cedex 9 (FR)

(21) Appl. No.: 18/266,969

(22) PCT Filed: Dec. 9, 2021
(86) PCT No.: PCT/FR2021/052262

§ 371 Date: Jun. 13, 2023

(30) Foreign Application Priority Data
Dec. 15, 2020 (FR) FR2013263

(51) Int. Cl. B60C 9/20

(52) U.S. Cl. CPC B60C 9/20; B60C 2009/2016; B60C 2009/2019; B60C 2009/209; B60C 2009/2093; B60C 2200/065

(57) ABSTRACT

A radial tire (1) for a heavy-duty vehicle, in which the reinforcing elements of each hooping layer (331, 332, 333), forming an angle at most equal to 5° with the circumferential direction, and the reinforcing elements of the transverse reinforcer layers (321, 322, 323), forming an angle of between 10° and 45° with the circumferential direction, are extensible and therefore such that, in their rubberized state extracted from a polymer matrix, their structural elongation As is at least equal to 0.5%, their total elongation at break At is at least equal to 3% and their tensile Young's modulus E is at most equal to 150 GPa.

The present invention relates to a radial tire intended to be fitted to a heavy-duty civil engineering vehicle, and more particularly concerns the crown reinforcement of such a tire.

Radial tires intended to be fitted to a heavy-duty civil engineering vehicle are designated within the meaning of the European Tire and Rim Technical Organisation, or ERTRO, standard.

For example, a radial tire for a heavy-duty civil engineering vehicle, within the meaning of the European Tire and Rim Technical Organisation, or ETRTO, standard, is intended to be mounted on a rim with a diameter at least equal to 25 inches. Although not limited to this type of application, the invention is described for a radial tire with large dimensions intended to be mounted on a dumper, in particular on vehicles for transporting materials extracted from quarries or surface mines, by means of a rim with a diameter at least equal to 35 inches, possibly as much as 57 inches, or even 63 inches.

Since a tire has a geometry which exhibits symmetry of revolution about an axis of rotation, the geometry of the tire is generally described in a meridian plane containing the axis of rotation of the tire. For a given meridian plane, the radial, axial and circumferential directions respectively denote the directions perpendicular to the axis of rotation of the tire, parallel to the axis of rotation of the tire and perpendicular to the meridian plane. The circumferential direction is tangential to the circumference of the tire.

Hereinafter, the expressions “radially inside” and “radially outside” respectively mean “closer to” and “further away from the axis of rotation of the tire”. “Axially inside” and “axially outside” respectively mean “closer to” and “further away from the equatorial plane of the tire”, the equatorial plane of the tire being the plane passing through the middle of the tread surface and perpendicular to the axis of rotation.

Generally, a tire comprises a tread intended to come into contact with the ground by means of a tread surface, the two axial ends of which are connected by means of two sidewalls to two beads that provide the mechanical connection between the tire and the rim on which it is intended to be mounted.

A radial tire further comprises a strengthening reinforcement made up of a crown reinforcement radially inside the tread, and a carcass reinforcement radially inside the crown reinforcement.

The carcass reinforcement of a radial tire for a heavy-duty civil engineering vehicle usually comprises at least one carcass layer comprising generally metal reinforcers, or reinforcing elements, that are coated in a polymeric material of the elastomer or elastomeric type obtained by blending and known as a coating compound. A carcass layer comprises a main part that connects the two beads together and is generally wound, in each bead, from the inside of the tire to the outside around a usually metal circumferential reinforcing element known as a bead wire so as to form a turn-up. The metal reinforcers of a carcass layer are substantially parallel to each other and form an angle of between 85° and 95° with the circumferential direction.

The crown reinforcement of a radial tire for a civil engineering vehicle comprises a superposition of crown layers extending circumferentially, radially outside the carcass reinforcement. Each crown layer is made up of generally metal reinforcers that are parallel to each other and coated in a polymeric material of the elastomer or coating compound type.

Among the crown layers, a distinction is usually made between protective layers, which make up the protective reinforcement and are radially outermost, and working layers, which make up the working reinforcement and are radially between the protective reinforcement and the carcass reinforcement.

The protective reinforcement, comprising at least one protective layer, essentially protects the working layers from mechanical or physicochemical attack that might spread through the tread radially towards the inside of the tire.

The protective reinforcement often comprises two radially superposed protective layers formed of extensible metal reinforcers that are parallel to each other in each layer and crossed from one layer to the next, forming angles at least equal to 10° with the circumferential direction.

The working reinforcement, comprising at least two working layers, has the function of belting the tire and conferring stiffness and road holding thereon. It absorbs both mechanical stresses of inflation, which are generated by the tire inflation pressure and transmitted by the carcass reinforcement, and mechanical stresses caused by running, which are generated as the tire runs over the ground and are transmitted by the tread. It must further withstand oxidation, impacts and punctures due to its intrinsic design and the design of the protective reinforcement responsible for protecting the other crown layers from external attack, tears or other punctures.

The working reinforcement usually comprises two radially superposed working layers formed of inextensible metal reinforcers that are parallel to each other in each layer and crossed from one layer to the next, forming angles at most equal to 60°, and preferably at least equal to 10° and at most equal to 45°, with the circumferential direction. For satisfactory absorption of the radial and transverse forces, designers seek to maximize the stiffness and breaking force of the reinforcing elements of the working layers.

In order to reduce the mechanical inflation stresses that are transmitted to the working reinforcement, it is known practice to position a hoop reinforcement radially outside the carcass reinforcement. The hoop reinforcement, the function of which is to at least partially absorb the mechanical stresses of inflation, improves the endurance of the crown reinforcement by stiffening the crown reinforcement. The hoop reinforcement can be positioned radially inside the working reinforcement, between the two working layers of the working reinforcement, or radially outside the working reinforcement.

In civil engineering applications, the hoop reinforcement can comprise two radially superposed hooping layers formed of metal reinforcers, parallel to each other in each layer and crossed from one layer to the next, forming angles at most equal to 10° but at least equal to 5° with the circumferential direction. In this case, the reinforcing elements of the hooping layers are placed in layers and stretch from one axial edge to the other of said hooping layers in less than one revolution of the tire on its axis of rotation.

The hoop reinforcement can usually comprise a hooping layer produced by the circumferential winding of a hooping wire or a continuous hooping strip forming angles at most equal to 5° with the circumferential direction.

With respect to the metal reinforcers, a metal reinforcer is mechanically characterized by a curve representing the tensile force (in N) applied to the metal reinforcer as a function of the relative elongation (as a %) thereof, known as the force-elongation curve. Mechanical tensile characteristics of the metal reinforcer, such as the structural elongation As (as a %), the total elongation at break At (as a %), the force at break Fm (maximum load in N) and the breaking strength Rm (in MPa), are derived from this force-elongation curve, these characteristics being measured in accordance with ASTM D 2969-04 of 2014.

The total elongation at break At of the metal reinforcer is, by definition, the sum of its structural, elastic and plastic elongations (At=As+Ae+Ap) and particularly at break, when each of the elongations is non-zero. The structural elongation As results from the relative positioning of the metal threads making up the metal reinforcer under a low tensile force. The elastic elongation Ae results from the actual elasticity of the metal of the metal threads making up the metal reinforcer, taken individually, the behavior of the metal following Hooke's law. The plastic elongation Ap results from the plasticity, that is the irreversible deformation beyond the elastic limit, of the metal of these metal threads taken individually. These different elongations and the respective meanings thereof, which are well known to a person skilled in the art, are described, for example, in U.S. Pat. No. 5,843,583, WO2005/014925 and WO2007/090603.

Also defined, at any point on the force-elongation curve of a metal reinforcer, is a tensile modulus, expressed in GPa, which represents the gradient of the straight line tangential to the force-elongation curve at this point. In particular, the tensile modulus of the elastic linear part of the force-elongation curve is referred to as the tensile elastic modulus or Young's modulus.

Among the metal reinforcers, a distinction is usually made between extensible metal reinforcers, such as those used in the protective layers, and inextensible or non-extensible metal reinforcers, such as those used in the working layers.

An extensible metal reinforcer, in its non-rubberized state, is characterized by a structural elongation As at least equal to 1% and a total elongation at break At at least equal to 3%. In addition, an extensible metal reinforcer has a tensile elastic modulus or Young's modulus at most equal to 180 GPa, and usually between 40 GPa and 150 GPa.

In its rubberized state extracted from a polymer matrix, namely a tire, an extensible metal reinforcer is characterized by a structural elongation As at least equal to 0.5% and a total elongation at break At at least equal to 3%, the polymer matrix preventing some of the movements of the threads responsible for structural elongation. In addition, an extensible metal reinforcer has, in its rubberized state extracted from a polymer matrix, a tensile elastic modulus or Young's modulus at most equal to 150 GPa, and usually between 40 GPa and 120 GPa.

An inextensible metal reinforcer is characterized by a total elongation At, under a tensile force equal to 10% of the force at break Fm, at most equal to 0.2%. Moreover, an inextensible metal reinforcer has a tensile elastic modulus usually between 150 GPa and 200 GPa.

When the tire runs on stones or other more or less sharp objects present on the tracks on which dumpers travel, the crown of a tire is frequently subject to cuts that can pass radially through it towards the inside and, depending on the size of the object, puncture the crown reinforcement and carcass reinforcement assembly, creating a loss of pressure and leading to the failure of the tire. The use of extensible metal reinforcers in the protective layers is known to improve the puncture resistance of tires by allowing improved adaptation of said protective layer to the shape of the obstacle; however, given the cost of these large tires and the frequency of these incidents, it is always beneficial to improve performance.

However, while these crown architectures are effective against relatively small or medium-sized obstacles, they are less effective against larger obstacles present in mines. Specifically, in such cases, the forces exerted on the cords are greater than the hardness of the steel and the obstacle therefore “cuts” the reinforcing elements of the working layers, and the stiffer these cords are, and the more they oppose the deformation imposed by the obstacle, the more easily they are cut.

The inventors set themselves the objective, for a radial tire for a civil engineering vehicle, of reducing the risk of the tire being punctured due to attacks on the tread when running over sharp stones, while retaining good crack resistance performance of the crown and allowing a reduction in the mass of the crown reinforcement.

This objective has been achieved, according to the invention, by a radial tire for a civil engineering vehicle comprising:
a crown reinforcement, radially inside a tread having an axial width Lbdr and radially outside a carcass reinforcement,
the crown reinforcement comprising at least two transverse reinforcer layers, one with a larger axial width having an axial width Ltmax and one with a smaller axial width having an axial width Ltmin,
each transverse reinforcer layer comprising metal reinforcing elements parallel to each other, forming oriented angles at least equal to 10° and at most equal to 45° with the circumferential direction, at least two angles of two transverse reinforcer layers being of opposite sign,
the crown reinforcement comprising at least one hooping layer having a maximum axial width Lfmax comprising extensible metal reinforcing elements parallel to each other and forming an angle at most equal to 5° with a circumferential direction (XX′) of the tire,
each reinforcing element of each of the layers of the crown reinforcement being characterized by a structural elongation As, a force at break Fm (maximum load in N), a breaking strength Rm (in MPa), a total elongation at break At and a tensile Young's modulus, these characteristics being measured in accordance with ASTM D 2696-04 of 2014,
each extensible metal reinforcing element of each hooping layer having, in its rubberized state extracted from a polymer matrix, a structural elongation Asf at least equal to 0.5%, a total elongation at break Atf at least equal to 3% and a tensile Young's modulus Ef at most equal to 150 GPa,
the reinforcing elements of the transverse reinforcer layers (321, 322, 323) being extensible and having, in their rubberized state extracted from a polymer matrix, a structural elongation Ast at least equal to 0.5%, a total elongation at break Att at least equal to 3% and a tensile Young's modulus Et at most equal to 150 GPa.

The invention consists of a tire in which all of the metal reinforcers of the crown reinforcement are extensible or hyperextensible, unlike the tires according to the prior art in which the working layers are inextensible in order to allow adequate circumferential and transverse stiffness. Surprisingly, in civil engineering tires, it is not essential to have inextensible working layers or transverse reinforcer layers if they are associated with one or more hooping layers with extensible reinforcing elements. What's more, using extensible cords for the working layers—or here, transverse reinforcer layers—allows for substantial increases in the puncture resistance of the crown and crack resistance, with a possible saving on mass.

In the prior art, apart from their relative positions, what distinguishes the working layers from the protective layers is, the protective layers being radially outermost, the difference in inextensible behavior of the working layers when the protective layers are extensible. In one of the simplest and most economical versions in terms of mass and therefore raw materials, the invention consists of a tire having one or two hooping layers and two extensible transverse reinforcer layers, at least one of which is radially outside the hooping layers. In this case, according to the vocabulary of the tires according to the prior art, the radially outermost transverse reinforcer layer is a protective layer, and has all of the features thereof, with the exception that a protective layer does not absorb any transverse force, as this is absorbed by the inextensible working layers in the tires according to the prior art. In this configuration, the radially outermost transverse reinforcer layer acts as a protective layer with respect to impacts and as a working layer with respect to absorbing transverse forces. Surprisingly, although all of the transverse reinforcer layers are extensible, but only insofar as there is one or more extensible hooping layers, the absorption of the transverse forces is such that in civil engineering applications, the behavior of the vehicle remains acceptable and the crack resistance at the end of the transverse reinforcer layers is retained or even improved.

In order for the invention to function correctly, the satisfactory absorption of the longitudinal forces must be ensured with the hooping layer(s) and extensible reinforcers must therefore be chosen that form an angle at most equal to 5° with the circumferential direction measured at the circumferential mid-plane. Preferably, this configuration is obtained by winding one or more reinforcers, in particular with a strip containing a plurality of reinforcers, around the tire. Even if a single reinforcer is laid, the hooping layer(s) is/are considered to comprise metal reinforcers that are parallel to each other, as the hooping layer actually comprises in its axial width a large number of reinforcer passages or passages of the same reinforcer, without it being possible to determine if it is a single reinforcer or two reinforcers butt-joined at the end of the first; this point has no effect on the behavior of the tire. By convention, the hooping layer(s) is/are therefore considered to comprise a plurality of metal reinforcers. However, for such metal reinforcer angles, laying in layers and not by winding a reinforcing element or a strip of a plurality of reinforcing elements can also be carried out on an industrial scale, but this type of laying requires a significant overlap of the layer at its longitudinal ends.

Preferably, the axial width Ltmin of the transverse reinforcer layer with a smaller axial width is at least equal to 70% of the axial width Lbdr of the tread and preferably at least equal to 80% of the axial width Lbdr of the tread. As the transverse reinforcer layers are extensible, these layers are preferably coupled over a minimum width of 70%, preferably 80%, of the width of the crown of the tire, that is, the width of the tread. Below this axial width of the transverse reinforcer layer with a smaller width, the transverse forces are less well absorbed and the behavior of the tire deteriorates, together with its crack resistance performance at the axial ends of the transverse reinforcer layers.

Advantageously, the axial width of at least one hooping layer is at least equal to 60% of the axial width Lbdr of the tread and preferably at least equal to 70% of the axial width Lbdr of the tread. Below this axial width of the hooping layer with a larger width, the longitudinal forces are less well absorbed and the shear forces at the axial ends of the transverse reinforcer layers increase, making the tire more susceptible to cracking.

Preferably, the total elongation at break Atf of the reinforcing elements of each hooping layer and the total elongation at break Att2 of the reinforcing elements of the second radially innermost transverse reinforcer layer are at least equal to 85% and at most equal to 110% of the total elongation at break Att1 of the reinforcing elements of the radially innermost transverse reinforcer layer, each of the reinforcers being in its rubberized state extracted from a polymer matrix. If the designer wishes to further protect the tire from puncturing, they will increase the number of crown layers and the structural and total elongation of the radially outermost reinforcer layer, which absorbs impacts first. If there is a difference in total elongation between the different crown layers, the two radially innermost transverse reinforcer layers will thus have a smaller total elongation than the radially outermost crown layer. The total elongations of each hooping layer and of the two radially innermost transverse reinforcer layers are thus preferably similar so that, in the event of an impact, they exhibit similar behavior and absorb the deformations in a balanced way, thus preventing the premature failure of one or other of said layers on impact with an obstacle.

Likewise, the structural elongation Asf of the reinforcing elements of each hooping layer and the structural elongation Ast2 of the second radially innermost transverse reinforcer layer are preferably at least equal to 85% and at most equal to 110% of the structural elongation Ast1 of the reinforcing elements of the radially innermost transverse reinforcer layer, each of the reinforcers being in its rubberized state extracted from a polymer matrix. This allows balanced functioning of the different crown layers with respect to inflation and running stresses.

Likewise, the Young's modulus Ef of the reinforcing elements of each hooping layer and the Young's modulus Et2 of the reinforcing elements of the second radially innermost transverse reinforcer layer (322) are preferably at least equal to 85% and at most equal to 110% of the Young's modulus Et of the reinforcing elements of the radially innermost transverse reinforcer layer, each of the reinforcers being in its rubberized state extracted from a polymer matrix. Like the preceding condition, this condition allows balanced functioning of the different crown layers, but in this case from the point of view of stresses rather than deformations.

Advantageously, the reinforcing elements of the two radially innermost transverse reinforcer layers and of the hooping layers have, in their rubberized state extracted from a polymer matrix, respective structural elongations at least equal to 1% and at most equal to 3%, which is the optimum range for the structural elongations of the reinforcers of said layers for improved puncture and impact resistance on the crown. If the structural elongation of said layers is too great, the tire deforms excessively and the rubber materials of the tire also deform significantly on inflation, consuming some of their crack resistance in particular. For rubberized extensible reinforcers extracted from a polymer matrix, a structural elongation of 0.5%, which is a lower limit of structural elongation, is not optimal for improved puncture resistance of the tire.

Likewise, the reinforcing elements of the two radially innermost transverse reinforcer layers and of the hooping layers preferably have, in their rubberized state extracted from a polymer matrix, respective Young's moduli at most equal to 85 GPa and at least equal to 50 GPa, for optimum behavior with respect crack and puncture resistance performance.

If the tire is solely intended for uses that do not include the most aggressive uses in terms of impacts by obstacles on the crown, all of the reinforcing elements of all of the transverse reinforcer layers advantageously have similar mechanical elongation and breaking characteristics so that there is no weak link in the attack resistance, in order for the behavior of the tire to remain as consistent as possible as a function of the drift angle applied to it and in order to optimize its crack resistance. In this case, for improved impact resistance behavior, the total elongation at break of the reinforcing elements of each transverse reinforcer layer is advantageously at least equal to 85% and at most equal to 110% of the total elongation at break Att of the reinforcing elements of the radially innermost transverse reinforcer layer, each of the reinforcers being in its rubberized state extracted from a polymer matrix. Likewise, for the same uses and for optimum behavior, the structural elongation of the reinforcing elements of each transverse reinforcer layer is preferably at least equal to 85% and at most equal to 110% of the structural elongation Ast of the reinforcing elements of the radially innermost transverse reinforcer layer, each of the reinforcers being in its rubberized state extracted from a polymer matrix. Likewise, for optimum crack resistance, the Young's modulus of the reinforcing elements of each transverse reinforcer layer is preferably at least equal to 85% and at most equal to 110% of the Young's modulus Ea of the reinforcing elements of the radially innermost transverse reinforcer layer, each of the reinforcers being in its rubberized state extracted from a polymer matrix. For the same use, the reinforcing elements of each transverse reinforcer layer advantageously have, in their rubberized state extracted from a polymer matrix, respective structural elongations at least equal to 1% and at most equal to 3%, which is the optimum range for the structural elongations of the reinforcers of said layers for optimum protection with the other performance relating to resistance against punctures and impacts on the crown.

The role in the protection of the crown of the radially outermost crown layer can be further specialized, whether it is a transverse reinforcer layer or a hooping layer, by increasing its elasticity relative to the other transverse reinforcer layers, if the tire also comprises at least two transverse reinforcer layers and at least one hooping layer in addition to this radially outermost crown layer. To this end, the reinforcing elements of the radially outermost crown layer advantageously have, in their rubberized state extracted from a polymer matrix, a structural elongation Asp at least equal to one percent plus the structural elongation Ast of the reinforcing elements of the radially innermost transverse reinforcer layer (Asp≥Ast+1%). In this configuration, the radially outermost crown reinforcing layer is preferably also the layer with the largest axial width so that this last layer provides effective puncture resistance with respect to small obstacles and to protect the ends of the other transverse reinforcer layers with respect to tramping stresses when running over large stones.

In the case of a tire comprising at least three transverse reinforcer layers and in which the reinforcers of the radially outermost transverse reinforcer layer have, in their rubberized state extracted from a polymer matrix, a structural elongation Asp greater than 110% of the structural elongation Ast of the radially innermost transverse reinforcer layer and more particularly greater than said elongation plus 1%, all of the transverse reinforcer layers radially inside the radially outermost transverse reinforcer layer advantageously exhibit similar elastic and break behavior so that the behavior of the tire remains as consistent as possible as a function of the drift angle applied to it and so that its crack resistance is optimized. In this case, for optimized resistance of the crown to mechanical attack, the total elongation at break of the reinforcing elements of each transverse reinforcer layer radially inside the radially outermost transverse reinforcer layer is advantageously at least equal to 85% and at most equal to 110% of the total elongation at break Att of the reinforcing elements of the radially innermost transverse reinforcer layer, each of the reinforcers being in its rubberized state extracted from a polymer matrix. Likewise, for improved road holding, the structural elongation of the reinforcing elements of each transverse reinforcer layer radially inside the radially outermost transverse reinforcer layer is preferably at least equal to 85% and at most equal to 110% of the structural elongation Ast of the reinforcing elements of the radially innermost transverse reinforcer layer, each of the reinforcers being in its rubberized state extracted from a polymer matrix. Likewise, for improved crack resistance, the Young's modulus Ef of the reinforcing elements of each transverse reinforcer layer radially inside the radially outermost transverse reinforcer layer is preferably at least equal to 85% and at most equal to 110% of the Young's modulus Ea of the reinforcing elements of the radially innermost transverse reinforcer layer, each of the reinforcers being in its rubberized state extracted from a polymer matrix. In the same case, the reinforcing elements of each transverse reinforcer layer radially inside the radially outermost transverse reinforcer layer advantageously have, in their rubberized state extracted from a polymer matrix, structural elongations at least equal to 1% and at most equal to 3%, which is the optimum range for the structural elongations of the reinforcers of said layers for optimum resistance in this configuration against punctures and impacts on the crown.

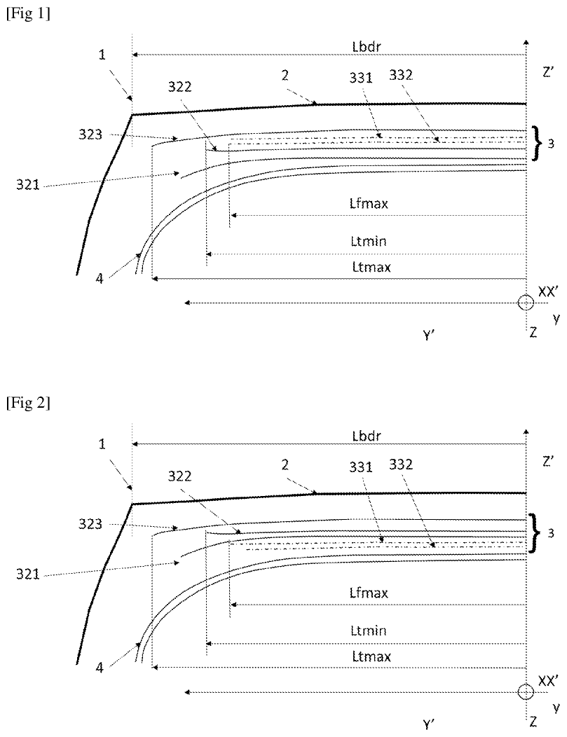

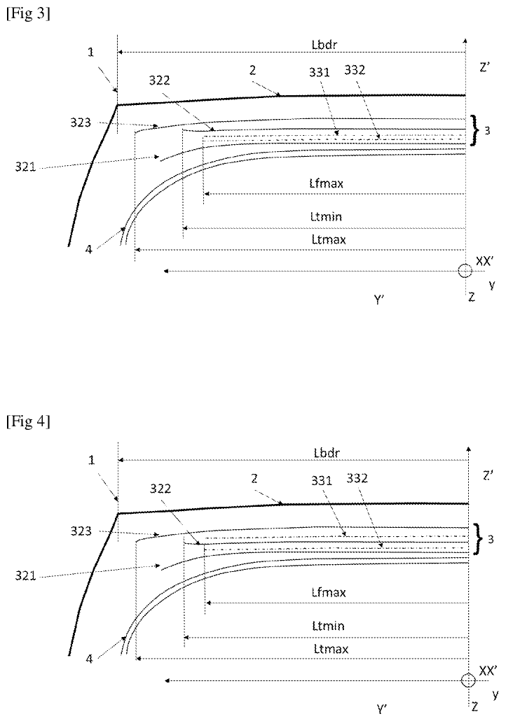

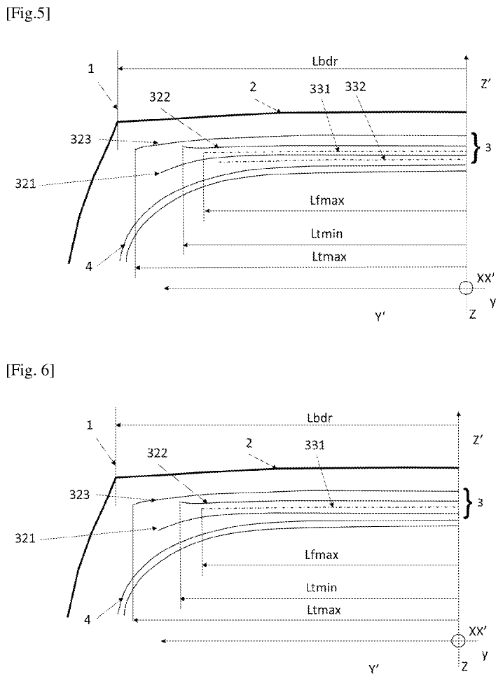

The features of the invention are illustrated in the schematic FIGS. 1 to 8, which are not to scale, with reference to a tire of size 24.00R35:

FIGS. 1 to 5: a meridian cross-section of a tire crown according to the invention comprising three transverse reinforcer layers and two hooping layers the position of which varies depending on the figure.

FIG. 6: a meridian cross-section of a tire crown according to the invention comprising three transverse reinforcer layers and one hooping layer.

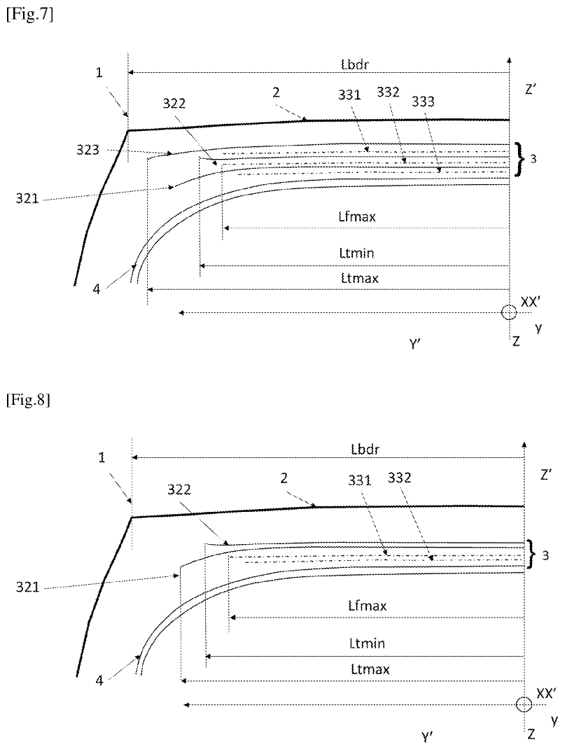

FIG. 7: a meridian cross-section of a tire crown according to the invention comprising three transverse reinforcer layers and three hooping layers.

FIG. 8: a meridian cross-section of a tire crown according to the invention comprising two transverse reinforcer layers and two hooping layers.

The figures do not show all of the possibilities offered by the invention. For example, for a version of the invention comprising two transverse reinforcer layers and two hooping layers as shown in FIG. 8, there are a number of possible variants of the positioning of the different layers included in the invention that are not shown. It is however preferable for the radially outermost reinforcing layer to be a transverse reinforcer layer and not a hooping layer, in particular to act as a barrier to sharp obstacles, as the orientation of the reinforcing elements of the hooping layers in the running direction makes them less effective for stopping the penetration of a sharp object.

The various figures show a meridian cross-section of a tire 1 for a heavy-duty civil engineering vehicle comprising a crown reinforcement 3 radially inside a tread 2 and radially outside a carcass reinforcement 4. The crown reinforcement 3 comprises transverse reinforcer layers 321, 322 and in some FIGS. 323, comprising extensible metal reinforcers coated in an elastomeric material, parallel to each other and forming an angle of between 10° and 45° with a circumferential direction XX′ tangential to the circumference of the tire, the metal reinforcers of the two radially innermost transverse reinforcer layers being crossed from one layer to the next. The crown reinforcement also comprises one, two or three hooping layers 331, 332, 333, in which the respective extensible metal reinforcers, coated in an elastomeric material and parallel with each other, form an angle at most equal to 5° with the circumferential direction XX′. The axial width of the tread Lbdr, the maximum axial width of the hooping layers Ltmax and the minimum and maximum axial widths Ltmin and Ltmax of the transverse reinforcer layers are also shown. In a configuration with three transverse reinforcer layers, the radially outermost transverse reinforcer layer will advantageously be more extensible than the other transverse reinforcer layers in order to provide the tire with improved crown attack resistance performance, particularly if all of the hooping layers are radially inside it.

The invention was tested on tires of size 24.00R35 with a 600 mm tread width. The tires according to the invention were compared with reference tires of the same size for each of the tests.

With respect to the puncture resistance performance of the crown, quasi-static tests were carried out using a cylindrical indenting tool 300 mm long, with a circular base with a diameter of 76.6 mm, the end of which, intended to come into contact with the tire, is beveled on symmetrical planes relative to the axis of the cylinder, the tip of the bevel having an angle of 46°.

The quasi-static test pushes the indenting tool in at a speed of 50 mm/min. The tire is compressed on flat ground with a force equal to the recommended load and the tire inflated to the recommended pressure. The indenting tool is pushed in at the center of the contact patch. The result of the test is the penetration distance necessary to break the crown reinforcement. The results are given in base 100, where 100 is the result on the reference tire. A result of more than 100 indicates better performance.

The crack resistance performance of the crown, also known as split resistance of the crown, is measured in tests on a machine in which two tires of the same type (reference tire on reference tire, tire according to the invention on tire according to the invention) run on each other at a speed of 28 km/h, with the tires inflated to 7.25 bar for a compressive force of 20 t. The test is conducted until one of the tires loses pressure. The result is the number of kilometers traveled before the failure of the tire.

The reference tires and the tires according to the invention are identical apart from the crown reinforcement. They have the same tread pattern and the same reinforcers for the carcass layer and the same rubber compounds for the different parts of the tire.

With respect to the crown reinforcement, from the radially outermost element to the radially innermost element, the reference tires are made up of: a protective reinforcement, a working reinforcement and a hoop reinforcement.
The reinforcing elements of the protective layers are E24.26 extensible cords (24 threads with a diameter of 26 hundredths of a millimeter), with a laying pitch of 2.5 mm, the structural elongation As of which, in their rubberized state extracted from a polymeric matrix, is equal to 0.6%, the total elongation at break At of which is equal to 3.9% and the Young's modulus of which is equal to 75 GPa. They form an angle of 24° with the circumferential direction and are crossed from one layer to the next. The radially outermost layer has an axial width of 520 mm and the other layer has an axial width of 400 mm
The reinforcing elements of the working layers are 26.30 inextensible cords (26 threads with a diameter of 30 hundredths of a millimeter), with a laying pitch of 3.4 mm, the structural elongation As of which, in their rubberized state extracted from a polymeric matrix, is equal to 0%, the total elongation at break At of which is equal to 2.4% and the Young's modulus of which is equal to 180 GPa. The radially innermost layer forms an angle of −33° and the radially outermost layer forms an angle of 19° with the circumferential direction and they are crossed from one layer to the next. The radially outermost layer has an axial width of 380 mm and the other layer has an axial width of 450 mm
The reinforcing elements of the hooping layers are identical to the reinforcing elements of the working layer with the same laying pitch. They form an angle of 8° with the circumferential direction and are crossed from one layer to the next. They are laid in the form of a ply. The radially outermost layer has an axial width of 200 mm and the other layer has an axial width of 240 mm.

Due to the stiffness of the working layers and the hooping layers, it is not possible to make the hooping layers wider. If only the hooping layers are extensible, they are no longer effective.

Two versions of the invention were tested, a so-called extensible version referred to as E and a so-called hyperextensible version referred to as HE. For the two versions E and HE of the invention, the crown reinforcement is identical with the exception of the reinforcing elements of the different crown layers. From the radially outermost element to the radially innermost element, the crown reinforcement is made up of:
A transverse reinforcer layer forming an angle of 33° with the circumferential direction, having an axial width of 520 mm
A transverse reinforcer layer forming an angle of 33° with the circumferential direction, crossed with the first transverse reinforcer layer, and having an axial width of 472 mm
Two hooping layers forming an angle of 0° with the circumferential direction, having an axial width of 400 mm.

For version E of the invention, all of the layers of the crown reinforcement are produced with reinforcing elements consisting of E21.28 cords (21 threads with a diameter of 28 hundredths of a millimeter) laid at a pitch of 2.4 mm, the structural elongation As of which, in their rubberized state extracted from a polymer matrix, is equal to 0.5%, the total elongation at break At of which is equal to 3.3% and the Young's modulus of which is equal to 95 GPa.

For version HE of the invention, all of the layers of the crown reinforcement are produced with reinforcing elements consisting of E24.35 cords (24 threads with a diameter of 35 hundredths of a millimeter) laid at a pitch of 4.2 mm, the structural elongation As of which, in their rubberized state extracted from a polymer matrix, is equal to 1.1%, the total elongation at break At of which is equal to 4.3% and the Young's modulus of which is equal to 70 GPa. The elasticity and hyperelasticity, or extensibility and hyperextensibility of the cords are obtained by adjusting the arrangement of the threads in the cord and also the compound placed between the threads.

The modulus of elasticity during the phase of structural elongation of the assembly of the extensible or hyperextensible cords of the reference tires or the tires according to the invention is between 10 and 20 GPa in their non-rubberized state, and between 10 and 30 GPa in their rubberized state extracted from a polymer matrix.

With respect to the penetration resistance performance, the results show that, despite the reduction of the weight of the tire by reducing the metal mass of its crown reinforcement, the critical height of the indenting tool during an impact on the surface of the tread is significantly greater. Version E shows a 10% improvement in performance and version HE a 20% improvement.

With respect to the tests relating to cracking or splitting of the crown, the tires according to the invention traveled 20% more kilometers than the reference tire before failure, which is a 20% improvement in performance.

With respect to performance relating to the mass of the tires, version E exhibits a 20% reduction in metal mass and version HE a 22% reduction, which for the tire tested is a reduction in mass of approximately 100 kg.

The invention as proposed therefore makes it possible to improve the crown puncture resistance and the crack resistance of the crown reinforcement while reducing the mass of the crown reinforcement and therefore the mass of the tire.

1. A radial tire for a civil engineering vehicle, comprising:
a crown reinforcement, radially inside a tread having an axial width Lbdr and radially outside a carcass reinforcement,
the crown reinforcement comprising at least two transverse reinforcer layers, one with a larger axial width having an axial width Ltmax and one with a smaller axial width having an axial width Ltmin,
each transverse reinforcer layer comprising metal reinforcing elements parallel to each other, forming oriented angles at least equal to 10° and at most equal to 45° with the circumferential direction, at least two angles of two transverse reinforcer layers being of opposite sign,
the crown reinforcement comprising at least one hooping layer having a maximum axial width Lfmax comprising extensible metal reinforcing elements parallel to each other and forming an angle at most equal to 5° with a circumferential direction (XX′) of the tire,
each reinforcing element of each of the layers of the crown reinforcement being characterized by a structural elongation As, a force at break Fm (maximum load in N), a breaking strength Rm (in MPa), a total elongation at break At and a tensile Young's modulus, these characteristics being measured in accordance with ASTM D 2696-04 of 2014,
each extensible metal reinforcing element of each hooping layer having, in its rubberized state extracted from a polymer matrix, a structural elongation Asf at least equal to 0.5%, a total elongation at break Atf at least equal to 3% and a tensile Young's modulus Ef at most equal to 150 GPa,
wherein the reinforcing elements of the transverse reinforcer layers are extensible and have, in their rubberized state extracted from a polymer matrix, a structural elongation Ast at least equal to 0.5%, a total elongation at break Att at least equal to 3% and a tensile Young's modulus Et at most equal to 150 GPa, and
wherein all of the metal reinforcers of the crown reinforcement are extensible.

2. The tire as claimed in claim 1, wherein the axial width Ltmin of the transverse reinforcer layer with a smaller axial width is at least equal to 70% of the axial width Lbdr of the tread (Ltmin≥0.7*Lbdr) and preferably at least equal to 80% of the axial width Lbdr of the tread (Ltmin≥0.8*Lbdr).

3. The tire (1) as claimed in claim 1, wherein the axial width of at least one hooping layer is at least equal to 60% of the axial width Lbdr of the tread (Lfmax≥0.6*Lbdr) and preferably at least equal to 70% of the axial width Lbdr of the tread (Lfmax≥0.7*Lbdr).

4. The tire as claimed in claim 1, wherein, the Young's modulus Ef of the reinforcing elements of each hooping layer and the Young's modulus Et2 of the reinforcing elements of the second radially innermost transverse reinforcer layer are at least equal to 85% and at most equal to 110% of the Young's modulus Et1 of the reinforcing elements of the radially innermost transverse reinforcer layer (321) (0.85*Et1≤Ef≤1.10*Et1 and 0.85*Et1≤Et2≤1.10*Et1), each of the reinforcers being in its rubberized state extracted from a polymer matrix.

5. The tire as claimed in claim 1, wherein the reinforcing elements of the two radially innermost transverse reinforcer layers and of the hooping layers have, in their rubberized state extracted from a polymer matrix, respective Young's moduli (Ef, Et) at most equal to 85 GPa and at least equal to 50 GPa.

6. The tire as claimed in claim 1, wherein the reinforcing elements of the two radially innermost transverse reinforcer layers and of the hooping layers have, in their rubberized state extracted from a polymer matrix, respective structural elongations (Asf, Ast) at least equal to 1%.

7. The tire as claimed in claim 1, wherein the reinforcing elements of the two radially innermost transverse reinforcer layers and of the hooping layers have, in their rubberized state extracted from a polymer matrix, respective structural elongations (Asf, Ast) at most equal to 3%.

8. The tire as claimed in claim 1, wherein the structural elongation Asf of the reinforcing elements of each hooping layer and the structural elongation Ast2 of the second radially innermost transverse reinforcer layer are at least equal to 85% and at most equal to 110% of the structural elongation Ast1 of the reinforcing elements of the radially innermost transverse reinforcer layer (0.85*Ast≤Asf≤1.10*Ast), each of the reinforcers being in its rubberized state extracted from a polymer matrix.

9. The tire as claimed in claim 1, wherein the radially outermost crown reinforcing layer is radially outside at least two transverse reinforcer layers and at least one hooping layer in which the reinforcing elements of the radially outermost crown layer have, in their rubberized state extracted from a polymer matrix, a structural elongation Asp at least equal to one percent plus the structural elongation Ast of the reinforcing elements of the radially innermost transverse reinforcer layer (Asp≥Ast+1%).
